(19) United States
(12) Patent Application Publication
(10) Pub. No.: US 2022/0053750 A1
(43) Pub. Date: Feb. 24, 2022

(54) DEVICE FOR TRAPPING INSECTS

(71) Applicant: ZOBELE HOLDING S.P.A., TRENTO (IT)

(72) Inventors: Moisés CABALLERO TAPIA, Barcelona (ES); Joaquim LLORENTE ALONSO, Barcelona (ES); Jorge Alejandro MARTÍNEZ URIBE, Barcelona (ES)

(21) Appl. No.: 17/418,403

(22) PCT Filed: Dec. 23, 2019
(86) PCT No.: PCT/EP2019/086936

§ 371 Date: Jun. 25, 2021

(30) Foreign Application Priority Data
Dec. 26, 2018 (ES) P201831281

(51) Int. Cl. A01M 1/14; A01M 1/02

(52) U.S. Cl. CPC A01M 1/145; A01M 1/023

(57) ABSTRACT

The device for trapping insects comprises an adhesive surface (4) for trapping insects; and a light source (2) for attracting the insects to said adhesive surface (4), which also comprises a chamber (1) provided with one or several holes (3), said light source (2) being placed inside said chamber (1) and said adhesive surface (4) is placed inside said chamber (1) or forms one of the inner walls of said chamber (1).

The presence of the chamber magnifies the light emitted by a light source and since the adhesive surface is located inside the chamber, the trapped insects remain concealed.

The present invention relates to a device for trapping insects comprising an adhesive surface whereon insects are trapped and a light that attracts insects to said adhesive surface.

### BACKGROUND OF THE INVENTION

There are devices for trapping insects which comprise a light, either UV or bluish light, for attracting flying insects so that they are trapped on a surface that has an adhesive.

These devices work when plugged into an electrical current and have a flat refill made of cardboard whereon insects become trapped. The dimensions thereof are quite large, as they are usually intended for industrial use and use a fluorescent lamp.

There are smaller variants on the market for household use, wherein the device is smaller and they use a cartridge with the adhesive surface inside as a refill, as well as a light-emitting diode (LED) for generating the attractant light.

There are also other battery-powered devices, which use a transparent plastic refill through which the light diffuses and which contain an adhesive on the outer surface thereof.

Currently known devices have some drawbacks. On the one hand, the devices have an adhesive surface and a light for attracting and trapping flying insects, they are usually very large and require a plug, which limits the places wherein they might be installed.

On the other hand, devices that have been designed for domestic use tend to have a fairly limited adhesive surface and generate a small beam of light, which is not very effective for attracting insects.

In portable devices, the light is limited to the effect of the transparent part and trapped insects are visible to the user. These devices usually have a high-intensity light-emitting diode (LED) that requires significant power, which reduces their useful life, due to the batteries, and the intensity thereof.

Therefore, a goal of the present invention is to provide a device for trapping insects wherein the light emitted by a light source is magnified and wherein the adhesive surface is found inside a chamber to conceal the trapped insects.

### DESCRIPTION OF THE INVENTION

The device of the invention is able to resolve the drawbacks mentioned above and exhibits other advantages that will be described below.

The device for trapping insects according to the present invention comprises:
an adhesive surface for trapping insects; and
a light source for attracting insects to said adhesive surface,
   wherein the device according to the present invention also comprises a chamber provided with one or several holes, said light source being placed inside said chamber and said adhesive surface is placed inside said chamber or forms one of the inner walls of said chamber.

The presence of the chamber magnifies the light emitted by a light source and since the adhesive surface is located inside the chamber, the trapped insects remain concealed.

According to two alternative embodiments, the device for trapping insects according to the present invention may also comprise a reflective surface inside said chamber, or said adhesive surface may also be reflective.

This reflective surface makes it possible to further magnify the light emitted by the light source.

Advantageously, said adhesive surface is assembled in the device in a removable manner and is used as a refill.

If desired, such adhesive surface may include insect attractants, such as pheromones or scents.

Furthermore, such adhesive surface advantageously comprises an assembly element for the assembly thereof to the rest of the device, such as, for example, a slot housing a complementary protrusion of the device.

In order to improve the attraction of insects, the light source is an ultraviolet or blue light source.

According to a possible embodiment, said adhesive surface is a sheet provided with at least one folding line, which facilitates the placement and removal thereof from the inside of the chamber by folding two sectors defined by the folding line or lines against each other in order to avoid contact with the trapped insects when said adhesive surface is removed.

### BRIEF DESCRIPTION OF THE DRAWINGS

To aid a better understanding of the above, drawings have been attached, in which a practical embodiment has been schematically represented and only by way of a non-limiting example.

FIGS. 1 and 2 are perspective views of the device of the present invention according to a first embodiment, in the use position and with the adhesive surface partially placed, respectively;

FIGS. 3 and 4 are perspective views of the device of the present invention according to a second embodiment, with the adhesive surface removed and placed in the use position thereof, respectively;

FIGS. 5 and 6 are perspective views of the device of the present invention according to a third embodiment, with the adhesive surface removed prior to the placement thereof and placed in the use position thereof, respectively;

FIGS. 7 and 8 are perspective views of the device of the present invention according to a fourth embodiment, with the adhesive surface removed prior to the placement thereof and placed in the use position thereof, respectively;

FIG. 9 is a perspective view of a fifth embodiment of the device according to the present invention, with the adhesive surface in the use position thereof; and

FIG. 10 is a perspective view of a sixth embodiment of the device according to the present invention, with the adhesive surface in the use position thereof.

### DESCRIPTION OF A PREFERRED EMBODIMENT

The device for trapping insects according to the present invention comprises a chamber 1 on the inside of which it houses a light source 2, for example, a light-emitting diode (LED), or any other type of light source emitting an ultraviolet or blue light. The light source 2 can be powered by any suitable means, preferably by means of batteries.

Said chamber 1 comprises at least one hole 3, which enables light to pass through and insects to enter the chamber 1.

In order to trap the insects, the device comprises an adhesive surface 4 (with adhesive on one face or on the two faces thereof) that can be placed inside the chamber 1 or can form a wall of said chamber 1. Furthermore, said adhesive surface 4 is assembled in the device in a removable manner and may be used as a refill. Thus, when there is an appropriate number of insects trapped on said adhesive surface 4, it can be removed and replaced with another.

It is important to note that the adhesive surface 4 is always oriented towards the inside of the chamber 1, although it could also be a sheet with adhesive on both sides placed inside the chamber or any type of body with adhesive surfaces situated inside the chamber 1.

To increase the magnification of the emitted light, the device also comprises a reflective surface, which may be the adhesive surface itself, an inner wall of the chamber, which may be adhesive or not, or another reflective surface placed inside the chamber.

Furthermore, the adhesive surface 4 can include any type of attractant for attracting insects, e.g. pheromones or scents, or similar.

The figures show different non-limiting embodiments, which will be described below.

For the sake of simplicity, all embodiments identify the same or equivalent elements with the same reference numbers.

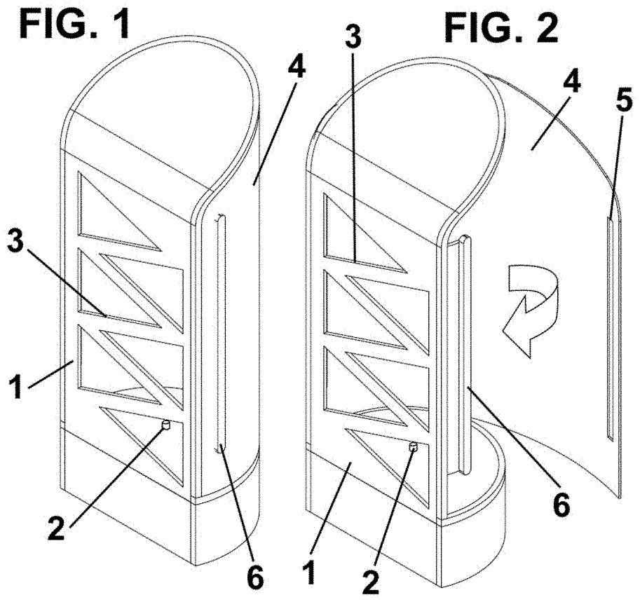

In the first embodiment, shown in FIGS. 1 and 2, the adhesive surface 4 forms the wall of the chamber 1 and comprises an assembly element, such as a slot 5 on one side for facilitating the assembly thereof, such that a protrusion 6 is housed inside said slot 5 for placing the adhesive surface 4 in the use position thereof.

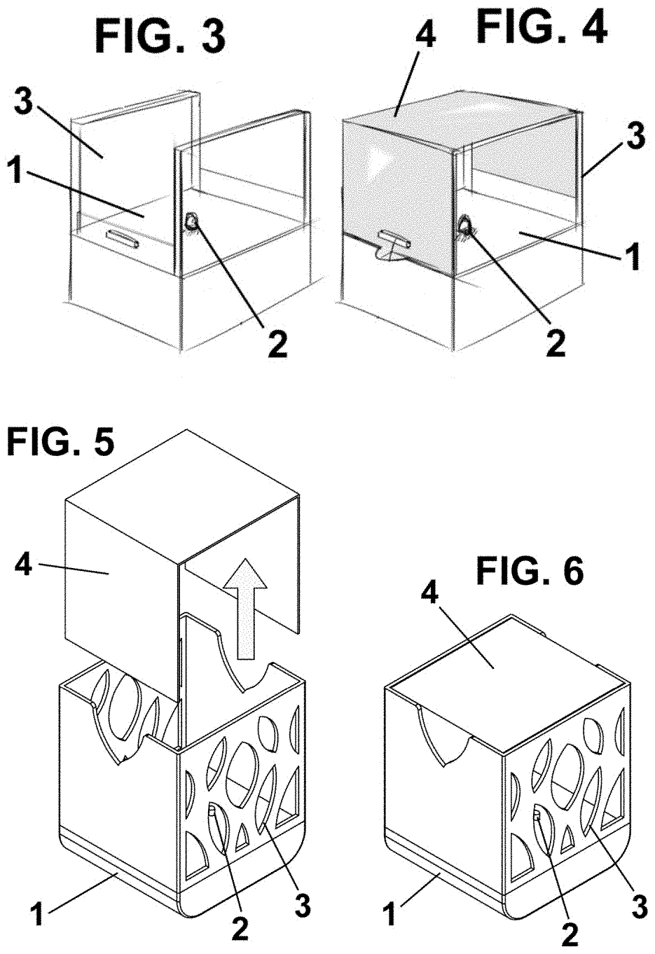

In the second embodiment, shown in FIGS. 3 and 4, the adhesive surface 4 comprises a couple of folding lines, defining three sectors, and those sectors, in the use position thereof, they form two side walls and the ceiling of the chamber 1. Also in this embodiment, there is an assembly element for assembling said adhesive surface 4, for example, a clip or protrusion 6 which is housed in a complementary slot of the adhesive surface 4.

As shown in FIG. 4, in this second embodiment, two sides of said chamber 1 are free to enable the passage of light and the entrance of insects.

The third embodiment, shown in FIGS. 5 and 6, is very similar to the second embodiment, except that the chamber 1 comprises two side walls without holes and two side walls with holes 3.

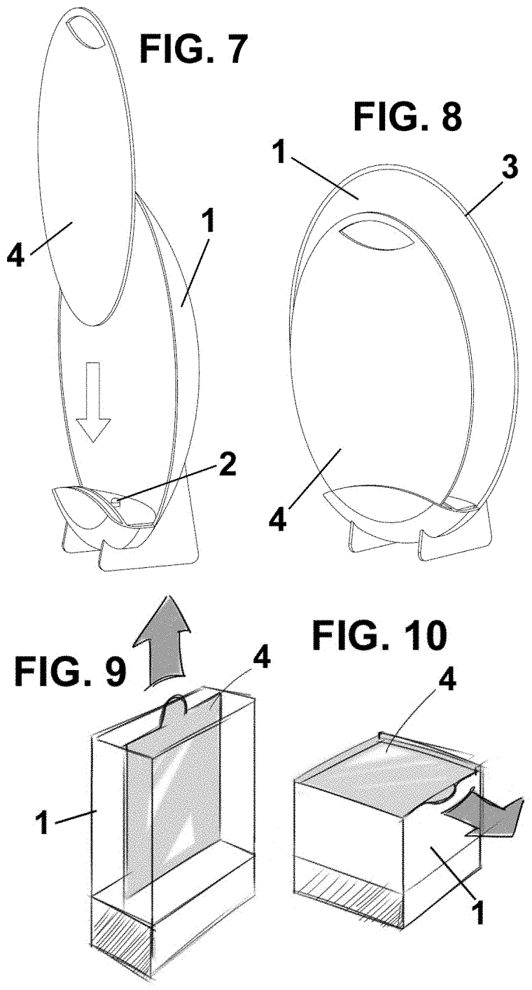

In the fourth embodiment, shown in FIGS. 7 and 8, the chamber 1 is formed based on a housing, wherein an adhesive surface 3 is placed to close said chamber 1 except for a peripheral hole or opening, forming a side wall.

If desired, the adhesive surface 3 may be printed on the outer surface thereof, for example, with designs that attract insects.

In the fifth embodiment, shown in FIG. 9, the adhesive surface 3 is placed inside the chamber 1 and, in the sixth embodiment, shown in FIG. 10, the adhesive surface 3 forms the ceiling of the chamber 1.

For the sake of simplicity, FIGS. 9 and 10 do not show the holes in the chamber, as they may be similar to any of the holes of the previous embodiments.

The operation of the device according to the present invention is very simple. Once the adhesive surface 4 is placed in the use position thereof, the light source 2 is turned on. Whenever the adhesive surface 4 loses efficiency due to the number of insects trapped or for any other reason, the adhesive surface 4 is removed and replaced by another.

Although reference has been made to several specific embodiments of the invention, it is obvious to a person with skill in the art that the device described is subject to numerous variations and modifications, and that all the details mentioned can be replaced by other technically equivalent ones, without departing from the scope of protection defined by the claims attached hereto.

1. A device for trapping insects, comprising:
an adhesive surface for trapping insects; and
a light source for attracting insects to said adhesive surface,
wherein the device for trapping insects further comprises a chamber provided with one or several holes or slots, said light source being placed inside said chamber and said adhesive surface being placed inside said chamber or forming one of the inner walls of said chamber.

2. The device for trapping insects according to claim 1, which also comprises a reflective surface inside said chamber.

3. The device for trapping insects according to claim 1, wherein said adhesive surface is also reflective.

4. The device for trapping insects according to claim 1, wherein said adhesive surface is assembled in the device in a removable manner.

5. The device for trapping insects according to claim 1, wherein said adhesive surface comprises insect attractants.

6. The device for trapping insects according to claim 5, wherein said attractants are pheromones or scents.

7. The device for trapping insects according to claim 1, wherein said adhesive surface comprises an assembly element for the assembly thereof to the rest of the device.

8. The device for trapping insects according to claim 7, wherein said assembly element is a slot housing a complementary protrusion of the device.

9. The device for trapping insects according to claim 1, wherein said light source is a source of ultraviolet or blue light.

10. The device for trapping insects according to claim 1, wherein said adhesive surface is a sheet provided with at least one folding line.
